(19) United States
(12) Patent Application Publication
(10) Pub. No.: US 2005/0282289 A1
(43) Pub. Date: Dec. 22, 2005

(54) Information acquisition method, information acquisition apparatus and sampling table for time of flight secondary ion mass spectroscopy

(75) Inventors: Kenji Ookubo, Atsugi-shi (JP); Hiroyuki Hashimoto, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/147,181

(22) Filed: Jun. 8, 2005

(30) Foreign Application Priority Data
Jun. 9, 2004 (JP) 2004-171304
Dec. 21, 2004 (JP) 2004-369417

(51) Int. Cl. G01N 24/00

(52) U.S. Cl. 436/173

(57) ABSTRACT

A method for analyzing an object by means of TOF-SIMS is adapted to apply an ionization promoter (metal such as silver or gold) to the object and generate secondary ions that correspond to parent molecules and can be used to determine the type of the object. A segregation/refinement technique such as electrophoresis or thin-layer chromatography can be employed for a mixed protein sample by using the method to obtain a two-dimensional image showing a high spatial resolution.

### BACKGROUND OF THE INVENTION

1. Field of the Invention

This invention relates to a method of acquiring information on the composition of mixed organic compounds, particularly of bio-related substances, by means of time of flight secondary ion mass spectroscopy, an information acquisition apparatus to be used for it and a sampling table for time of flight secondary ion mass spectroscopy.

2. Related Background Art

In line with the recent development of genome analysis technologies in recent years, the significance of analysis of proteins existing in living bodies as genetic products has been increasingly attracting attention.

The significance of expression and functional, analysis of proteins has been pointed out and various analytical techniques have been developed. Known techniques are essentially based on the combination of:

(1) segregation and refinement of proteins by means of two-dimensional electrophoresis and high performance liquid chromatography (HPLC); and

(2) detection by means of radiation analysis, optical analysis, mass analysis or the like.

The development of protein analysis technologies has been made in two categories including the category of construction of databases by way of proteome analysis (comprehensive analysis of proteins in cells) and that of provision of diagnostic devices and pharmaceutical devices (for screening candidate medicines) that are based on such databases. Regardless of the area of application, there is a demand for compact and automated high performance devices that outdo conventional devices in terms of analyzing time, throughput, sensitivity, resolution and flexibility. The development of protein chips that highly densely and integrally combine proteins is attracting attention because they represent techniques necessary for meeting the demand.

Protein chips are formed by capturing expressed specific proteins by utilizing the antigen-antibody reaction or the like and the captured proteins are analyzed by means of fluorescence analysis, surface plasmon resonance analysis, radioisotope labeling, matrix-assisted laser desorption ionization (MALDI) mass analysis or the like. A mass analysis method that utilizes field emission is also known as a technique of protein analysis (Japanese Patent Application Laid-Open Publication No. 2001-521275). This method causes an expressed specific protein arranged on a metal electrode to produce covalent bonds or coordinate bonds by way of releasing groups that can be cleaved as a function of the applied energy and leads it to a mass spectrometer by applying a strong electric field to it.

One of the reasons why protein chips are popularly used as a segregation and refinement technique for detection methods as listed above is that protein chips show an appropriate spatial spread relative to the spatial resolution of such a detection method.

For example, the MALDI mass analysis method and the SELDI mass analysis method, which has been developed by improving the former method, are the currently known softest ionization methods and have a remarkable feature of being able to ionize proteins that have a large molecular weight and are apt to be broken and detect parent ions or their equivalents. For this reason, they are currently standard ionization methods for mass analysis of proteins. On the other hand, when such a method is applied to mass analysis of protein chips, it faces a limit with regard to spatial resolution when detecting a two-dimensional distribution image of proteins (imaging proteins, using mass information) because of the existence of a matrix substance. More specifically, while a laser beam that operates as source of excitation can be converged to a spot with a diameter of 1 to 2 μm without difficulty, the spatial resolution of a two-dimensional distribution image of proteins is generally about 100 μm when the above detection method is used because of evaporation or ionization of the matrix substance existing around the proteins to be analyzed. Additionally, the lens and the mirror of the observation system need to be moved in a complex manner when scanning the conversed laser beam. In other words, when observing a two-dimensional distribution image of proteins with the above detection method, it is difficult to scan the laser beam and the technique that can be used for scanning is only the one for moving the sample stage on which the sample to be analyzed is mounted. When acquiring a two-dimensional distribution image of proteins with a high spatial resolution, the technique of moving the sample stage can be undesirable (and disadvantageous from the viewpoint of reliability because of the mechanically movable part).

The scope of application of any of the remaining known detection methods is also limited for a number of reasons including that it is also difficult to acquire a two-dimensional distribution image of an object of observation and the object of observation needs to be rigidly secured to a metal electrode.

Thus, from the viewpoint of spatial resolution of detection method, protein chips have been attracting attention because they can segregate and refine proteins with a sufficient level of spatial resolution.

Meanwhile, time of flight secondary ion mass spectroscopy (to be referred to as TOF-SIMS hereinafter) has become increasingly popular for the purpose of mass analysis of proteins because it is a highly sensitive means of mass analysis and surface analysis. TOF-SIMS is an analysis method for seeing the atoms or molecules existing on the uppermost surface of a solid sample and has characteristic features as described below. That is, it is capable of detecting a micro-content of 10⁹ atoms/cm (a quantity equivalent to 1/10⁵ of the uppermost mono-atomic layer) and is applicable to both organic and inorganic substances, while it is capable of observing all the elements and all the compounds existing on the surface and imaging secondary ions coming from the substances existing on the surface of the sample.

Now, the underlying principle of this method will be briefly described below.

When a pulse ion beam (primary ions) is irradiated onto the surface of a solid sample at high speed in vacuum of an enhanced degree, some of the components of the surface are emitted into vacuum due to a sputtering phenomenon. The positively or negatively charged ions (secondary ions) that are generated at this time are converged to a given direction by applying an electric field and detected at a point separated from the surface by a predetermined distance. Secondary ions having various different masses are generated depending on the composition of the surface of a solid sample when a pulse of primary ions is irradiated onto the solid surface. Since light ions fly at high speed and heavy ions fly at low speed, it is possible to analyze the mass of each generated secondary ion by metering the time spent by the ion between the generation and the detection thereof (time-of-flight). It is hence possible to acquire information on the uppermost surface of a sample because only the secondary ions generated at the outermost surface of a solid sample are emitted into vacuum when primary ions are irradiated onto the surface. Since TOF-SIMS involves only an extremely low rate of primary ion irradiation, organic compounds are ionized, maintaining their chemical structures to make it possible to know the structures of the organic compounds from the observed mass spectrum. However, when artificial polymers such as polyethylene and polyester and biopolymers such as proteins are analyzed by TOF-SIMS under ordinary conditions, they become small discomposed fragment ions and hence it is generally difficult to know their respective original structures. When a solid sample is an electric insulator, it is possible to analyze the insulator because the positive charge that is accumulated on the solid surface can be neutralized by irradiating a pulse of electronic rays into the gaps of the primary ions that are being irradiated as a pulse. Additionally, it is possible to observe an image of ions on the surface of a sample (mapping) with TOF-SIMS by scanning a primary ion beam.

Known studies on protein analysis using TOF-SIMS include one labeling part of a specific protein by means of an isotope such as ¹⁵N and detecting an image of the protein by means of secondary ions such as C¹⁵N⁻ (1A. M. Belu et al., Anal. Chem., 73, 143 (2001)), one estimating the type of protein on the basis of the type and the relative intensity of fragment ions (secondary ions) that correspond to the amino acid residues (D. S. Mantus et al., Anal. Chem. 65, 1431 (1993)) and one looking into the limit of detection by TOF-SIMS for the proteins adsorbed onto various substrate (M. S. Wagner el. Al., J. Biomater. Sci. Polymer Edn., 13, 407 (2002)).

With the TOF-SIMS method, it is possible to acquire an image of secondary ions (two-dimensional distribution image) showing a high spatial resolution because, unlike a laser beam, it is easy to converge primary ions and employ converged primary ions for scanning. It is possible with TOF-SIMS to achieve a spatial resolution of about 1 μm. However, when TOF-SIMS is used for observing an object on a substrate under ordinary conditions, the generated secondary ions are mostly small decomposed fragment ions and it is generally difficult to know the original structure as pointed out above. For this reason, a technique has to be devised to acquire an image of secondary ions (two-dimensional distribution image) showing a high spatial resolution for a protein chip or some other sample where a plurality of proteins are arranged on a substrate. The technique proposed by A. M. Belu is labeling part of a specific protein by means of isotopes. It is a technique designed to sufficiently exploit the high spatial resolution of TOF-SIMS. However, it is not practically acceptable to label a specific protein by means of isotopes. With the technique proposed by D. S. Mantus et al. of estimating the type of protein on the basis of the type and the relative intensity of fragment ions (secondary ions) that correspond to the amino acid residues, it is difficult to estimate the type of protein when some other proteins having a similar amino acid structure is mixed there.

Known techniques for segregation and mass analysis of proteins other than those cited above include one designed to enhance the protein segregation capability by means of high performance liquid chromatography (Japanese Patent No. 3376955). However, this patent document does not describe identification of the segregated proteins by mass analysis. Another patent document (Japanese Patent No. 3035357) discloses a method of detecting a specific protein and a technique of mass analysis using the method but it is not aimed to detect usual proteins and mixtures thereof.

Known methods of diagnosing the health condition of a subject by analyzing a sample taken from the living body of the subject include one designed to filter, segregate and analyze blood (Japanese Patent Application Laid-Open Application No. 2001-258868). However, practically there is no known method of diagnosing the health condition of a subject from the protein mass information acquired by two-dimensionally spreading a sample (two-dimensional distribution pattern on a mass by mass basis).

Thus, in the field of protein detection by means of protein chips, utilization of a detector for segregating and refining proteins in spatial regions identifiable by the detector as a diagnostic device or a pharmaceutical device (for screening candidate medicines) is attracting attention.

However, protein chips involve problems including high manufacturing cost, the difficulty of comprehensive researches on diagnosis of unknown symptoms due to the limited number of types of protein that can be mounted on a chip, generation of non-specific adsorption of proteins and modification of proteins that can take place at the time of fixation.

### SUMMARY OF THE INVENTION

Firstly, the present invention utilizes the fact that it is possible to accelerate the ionization of proteins by making them coexist with an agent for accelerating ionization, which may be a metal such as silver or gold, and analyze them with TOF-SIMS that has not hitherto been an appropriate means for protein analysis although it provides a high spatial resolution. Secondly, it utilizes the fact that, since TOF-SIMS provides a high spatial resolution for various measurements, it is possible to use a technique of comprehensively segregate proteins at low manufacturing cost such as electrophoresis or thin layer chromatography without relying on known techniques using protein chips for segregation and refinement of proteins. A member of proteins can be continuously segregated partly in a mixture by this technique and hence it is now possible to grasp the composition of the sample unlike known detection methods (e.g., partial extraction, mass analysis after condensation).

Thus, according to the invention, there is provided an information acquisition method of acquiring a secondary ion mass spectrum of an object by means of time of flight secondary ion mass spectroscopy, said method comprising:

a first step of segregating the object;

a second step of applying an ionization promoter to said object; and

a third step of obtaining a secondary ion mass spectrum of the object by means of time of flight secondary ion mass spectroscopy.

Preferably, an information acquisition method according to the invention further comprises a step of decomposing the object by way of a chemical process after said first step. The expression of “decomposing the object by way of a chemical process” refers to “decomposition of DNA by means of a restriction enzyme or decomposition of protein by means of protease” throughout this patent document.

Preferably, in an information acquisition method according to the invention, said first step of segregating the object is a step of segregating the object by electrophoresis or thin-layer chromatography that involves the use of a segregator containing an ionization promoter and having a mechanism capable of segregating the object.

Preferably, said object is a bio-related substance. For the purpose of the present invention, a bio-related substance refers to a nucleic acid such as DNA or RNA or a protein, preferably a nucleic acid, a protein or a decomposition product thereof obtained by decomposition by way of a chemical process. For the purpose of the present invention, an ionization promoter is preferably a substance (which may be a mixture) containing a metal, more preferably silver, gold or a mixture thereof.

Preferably, in an information acquisition method according to the invention, information on the two-dimensional distribution of said object is acquired by scanning a primary ion beam.

In another aspect of the present invention, there is provided an information acquisition apparatus comprising a time-of-flight type secondary ion mass spectrometer, the sampling table of the apparatus containing an ionization promoter and having a mechanism for segregating the object.

Preferably, an information acquisition apparatus according to the invention has a mechanism for decomposing the segregated object by way of a chemical process.

In still another aspect of the present invention, there is provided a sampling table for time of flight secondary ion mass spectroscopy containing an ionization promoter and has a mechanism for segregating an object.

Preferably, said sampling table is a plate for thin-layer chromatography containing an ionization promoter.

In still another aspect of the present invention, there is provided a method of acquiring information on health condition by means of an information acquisition method according to the invention, wherein said object is a sample taken from a living body. Preferably, in a method of acquiring information on health condition according to the invention, said sample is rigidly secured to the sampling table that is removable from an information acquisition apparatus.

With a method of acquiring information on health condition according to the invention, it is possible to acquire information on health condition by comparing the acquired secondary ion mass spectrum information and the segregated pattern information with library data of secondary ion mass spectrum information and segregated pattern information prepared in advance to correspond to various health conditions.

### BRIEF DESCRIPTION OF THE DRAWINGS

FIGS. 1A and 1B are partially enlarged view of the positive secondary ion mass spectrum obtained in Example 2. FIG. 1A shows a spectrum obtained by an actual measurement and FIG. 1B shows a theoretical spectrum obtained by computations on the basis of the isotopic abundance ratio;

FIG. 2 is a schematic illustration of the steps of an information acquisition method according to the invention;

FIG. 3 is a schematic cross sectional view of a sampling table according to the invention; and

FIG. 4 is an enlarged schematic perspective view of a sampling table according to the invention.

### DESCRIPTION OF THE PREFERRED EMBODIMENTS

Now, the present invention will be described in greater detail by referring to the accompanying drawings that illustrate preferred embodiments of the invention.

An information acquisition method of acquiring a secondary ion mass spectrum of an object by means of time of flight secondary ion mass spectroscopy according to the invention comprises a first step of segregating the object by means of electrophoresis or thin-layer chromatography, a second step of applying an ionization promoter to the object by means of evaporation or chemical modification and a third step of obtaining a secondary ion mass spectrum of the object by means of time of flight secondary ion mass spectroscopy.

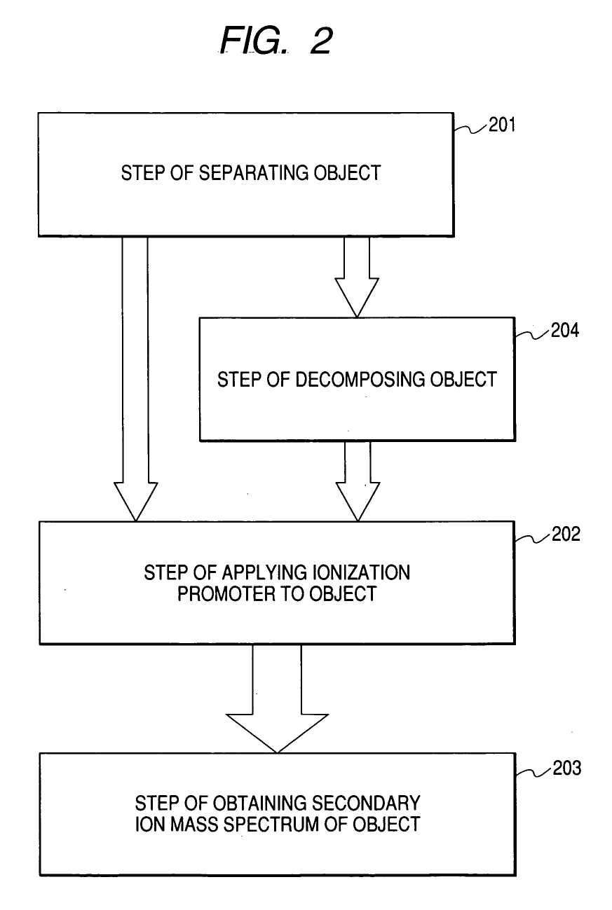

FIG. 2 is a schematic illustration of the steps of an information acquisition method according to the invention. In FIG. 2, 201 denotes the step of segregating the object and 202 denotes the step of applying an ionization promoter to the object, whereas 203 denotes the step of obtaining a secondary ion mass spectrum of the object by means of time of flight secondary ion mass spectroscopy and 204 denotes the step of decomposing the object, which is designed to decompose, if necessary, the object to a desired size before the time of flight secondary ion mass spectroscopy to make it possible to enhance the accuracy of analysis by making a collective judgment, taking the result of other analyses into consideration.

Now, each of the above-cited steps will be described in greater detail below.

Firstly the first step of segregating the object will be described.

The technique for segregating the object for the purpose of the present invention is required to segregate the components of the sample with a positional stretch (in two-dimensional directions) in order to exploit the characteristics of the two-dimensional imaging of TOF-SIMS. Examples of segregation techniques that can be used for the purpose of the present invention include electrophoresis and thin-layer chromatography. Note that it is necessary to sufficiently dry the segregated sample/substrate because they need to be placed in a high degree of vacuum during the measuring operation using TOF-SIMS. Two or more than two segregation techniques may be combined for this step. For example, “positional information” that provides a cue for identifying the component organic substances can be acquired by segregating the components of the sample, using a C8 (a plate where C₈H₁₇ is fixed) and a C18 (a plate where C₁₈H₃₇ is fixed) that are different from each other in terms of segregation mode.

Now, the second step of making the object to coexist with an ionization promoter in order to accelerate the ionization of the object will be described below.

For the purpose of the present invention, the substance that accelerates the ionization of the object (object ionization promoter) may be referred to as sensitizing substance whenever necessary.

The techniques that can be used for applying a substance for accelerating the ionization of the object include the following:

(1) applying it after arranging the object on the substrate;

(2) applying it in advance to a specific type or a plurality of specific types of object arranged on the substrate; and

(3) applying to the surface of the substrate in advance before the object is arranged on the substrate. Concrete examples of the applying technique include an evaporation, chemical modification, and so forth.

Of the above techniques, the technique of (1) is applicable to the analysis of an object of any form. In other words, it is a highly general purpose technique. On the other hand, care needs to be taken so as not to diffuse the object in the process of applying a substance that accelerates the ionization of the object that is two-dimensionally distributed on the substrate because the objective of the present invention is not achieved when the two-dimensional distribution of the object is altered in the process, which may involve chemical modification. It is possible to judge if the two-dimensional distribution of the object is altered or not by comparing the results of the analysis using TOF-SIMS before the chemical modification process and those after the chemical modification process.

The technique of (2) is to bond a substance (sensitizing substance) that accelerates the ionization of the object and improves the sensitivity of the object in the analysis using TOF-SIMS to a specific site of the specific object. This technique provides an advantage that the two-dimensional distribution of the specific object can be selectively detected with an enhanced level of sensitivity. On the other hand, it is accompanied by a disadvantage that it requires a chemical modification process for each object to make the overall operation a relatively complex one. Bonding techniques that can be used for bonding the sensitizing substance include covalent bonding and ionic bonding as well as coordinate bonding in case of using a metal complex as sensitizing substance and are not subject to any limitations. However, the bond needs to be stable because the object that is arranged on the substrate may be chemically processed protein.

The technique of (3) is to form a substance (sensitizing substance) in advance that accelerates the ionization of the object and improves the sensitivity of the object in the analysis using TOF-SIMS on the surface of the substrate. It is important for this technique to thoroughly check in advance if a problem of non-specific adsorption arises anew due to the existence of the sensitizing substance or not. Any sensitizing substance may be used without particular limitations so long as it can raise the sensitivity of the object in the analysis using TOF-SIMS. The sensitizing substance is not required to be directly bonded to the object (and it is sufficient for it to show an effect of raising the efficiency of ionizing the object in the process of generating secondary ions in the analysis using TOF-SIMS). While the sensitizing substance is preferably formed on the uppermost surface of the substrate, it is also possible to arrange a third substance on the sensitizing substance to the thickness of a monomolecular film or so in order to prevent non-specific adsorption from taking place.

Now, the ionization promoter (sensitizing substance) to be used for the purpose of the present invention will be described below.

On the basis of the findings of the inventors of the present invention, they believe that the effect of using an ionization promoter that acts on the object to improve the efficiency of the generation of secondary ions when irradiating primary ions onto the object is achieved for the reasons as described below.

If the object is a sample obtained from a living body, peptide chains of protein molecules of the object of measurement are entangled with each other in the living organism. The entanglement is a factor of reducing the efficiency of generating secondary ion species in the measurement operation using TOF-SIMS. On the other hand, according to the invention, a solution containing an ionization promoter is made to act on the surface of the sample taken from a living body to improve the efficiency of generating secondary ion species that derive from protein molecules existing on the surface. The ionization promoter is a substance that accelerates and boosts the generation of secondary ion species deriving from protein molecules existing on the surface when irradiating primary ions onto the sample.

A specific example of technique for applying the ionization promoter is applying a solution containing a sensitizing substance to the surface of the sample to cover the entire surface and holding the surface to the covered state in order to make the ionization promoter directly act on protein molecules existing on the surface of the sample taken from a living body.

For instance, if a dilute aqueous solution of silver nitrate is used as a solution containing an ionization promoter, silver ions dissociated in the aqueous solution act on peptide chains that form protein molecules to produce bonds among silver ions and protein molecules and accelerate generation secondary ion seeds. Thus, the inventors of the present invention believe that the ionization promoter itself or one or more than one of the components thereof acts on peptide chains that form protein molecules and produce bonds with peptide chains to consequently undo the entanglement of peptide chains of protein molecules.

Additionally, since silver is a substance that can be ionized with ease per se, the inventors also believe that it exerts an effect of accelerating the ionization of protein by bonding itself to protein molecules.

Examples of ionization promoters that can be used for the purpose of the present invention include silver nitrate, which is pointed out above, and other metal salts such as sodium carbonate, substances containing a metal such as gold or silver (metal complexes) and metal colloids. The solution containing an ionization promoter is preferably an aqueous solution.

For the purpose of the present invention, chemical modification refers without limitations to any process having an effect of boosting the efficiency of ionizing protein when generating secondary ions in an analytic-operation using TOF-SIMS so long as it does not alter the two-dimensional distribution of the protein, although the use of a substance that contains a metal as chemical modifier is preferable. The use of silver and/or gold is preferable as metal contained in the substance as far as the study of the inventors of the present invention goes, although some other metal may alternatively be used when it provides the above identified effect.

A technique that can be used for chemical modification for the purpose of the present invention is that of adding silver or silver ions to a plurality of different types of protein arranged on a substrate by utilizing a silver mirror test. For the purpose of the present invention, the silver mirror test is a reaction process of adding a sample to an aqueous ammoniac silver nitrate solution and subsequently reducing diammine silver (I) ions to precipitate silver. This reaction is particularly effective to protein that contains cysteine (Cys). When using this reaction for the protein that is two-dimensionally distributed on a substrate, care should be taken so as not to diffuse the protein as a result of the reaction process. A commercially available agent (e.g., “Silver Dying II Kit Wako”, available from Wako Pure Chemical Industries, Ltd.) may be used as agent for the reaction. It is also possible to provide an effect of accelerating the ionization of the object by directly spraying atomized aqueous solution of silver nitrate.

However, techniques that can be used for chemical modification for the purpose of the-present invention are not limited to those listed above and any technique may be used for the purpose of the present invention so long as it provides the effect of boosting the efficiency of generating secondary ions of the object in the analysis using TOF-SIMS and does not alter the two-dimensional distribution of the object.

Finally, the third step of acquiring information on the mass of the object (secondary ion mass spectrum) by means of time-of-flight secondary ion mass spectrometry will be described below.

Detection (imaging) of the two-dimensional distribution of the object for the purpose of the present invention is characterized by using secondary ions that can be used to identify the object. The mass/electric charge ratio of the secondary ions is preferably not smaller than 500, more preferably not smaller than 1,000. The reason for this is that amino acids of protein typically have a mass number of 100 to 200 and hence it is possible to detect 5 to 10 amino acid sequences as useful data for identifying protein to a great advantage of identifying protein when the mass/electric charge ratio is not smaller than 1,000.

Examples of primary ion species that can preferably be used for the purpose of the present invention include gallium ions, cesium ions and, in certain cases, gold (Au) ions from the viewpoint of ionization efficiency, mass resolution, etc. The use of Au ions is preferable because it can raise the sensitivity of the analysis. Not only Au ions but also Au₂ ions and Au₃ ions, which are multi-atom ions of gold, may be used as primary ion species and the sensitivity can be improved in the mentioned order. In other words, the use of multi-atom ions of gold is a further preferable mode of operation.

Preferably, the primary ion beam pulse frequency is within a range between 1 kHz and 50 kHz. Preferably, the primary ion beam energy is within a range between 12 keV and 25 keV. Preferably, the primary ion beam pulse width is within a range between 0.5 ns and 10 ns.

For the purpose of the present invention, it is necessary to complete the measurement operation in a relatively short period of time in order to maintain a high mass resolution and improve the quantitative accuracy (in the order of tens of several seconds to tens of several minutes for a measuring session). Therefore, it is preferable to sacrifice the diameter of the primary ion beam by a certain extent. More specifically, it is preferable not to reduce the diameter of the primary ion beam to the order of sub-microns but to select a range between 1 μm to 10 μm for the diameter because then it is possible to specify the duration of the measurement operation to a short period of time.

Then, it is possible to analyze the components of the sample on the basis of the acquired information on the mass number of secondary ions and the pattern information (of the segregated object) acquired by imaging the secondary ions.

More specifically, a component analysis according to the invention can acquire information for accurately identifying mixed organic samples as a result of the second step of accelerating the ionization of the sample by using a substance for accelerating the ionization of the object (ionization promoter) and additionally by using the information for identifying the information on the position of segregation that is specific to each of the components segregated in the first step of segregating the object. For example, in the case of thin-layer chromatography, it is possible to segregate all the samples of organic substances to respective specific positions with an enhanced level of reproducibility under the same conditions of segregation. Then, it is possible to obtain secondary ions showing a large mass/electric charge ratio that is advantageous for identifying samples by observing the samples by means of TOF-SIMS, while causing silver to coexist with them. Then, it is possible to accurately identify the mixed organic samples by using all the acquired pieces of, information in a coordinated manner. Particularly, if a database library is prepared for the protein composition of each specific site of living bodies in terms of the mass number of secondary ions and the position of segregation for it, it is possible to quickly identify the change in the composition due to a change in the health condition, which is useful for diagnosing the health condition of a subject.

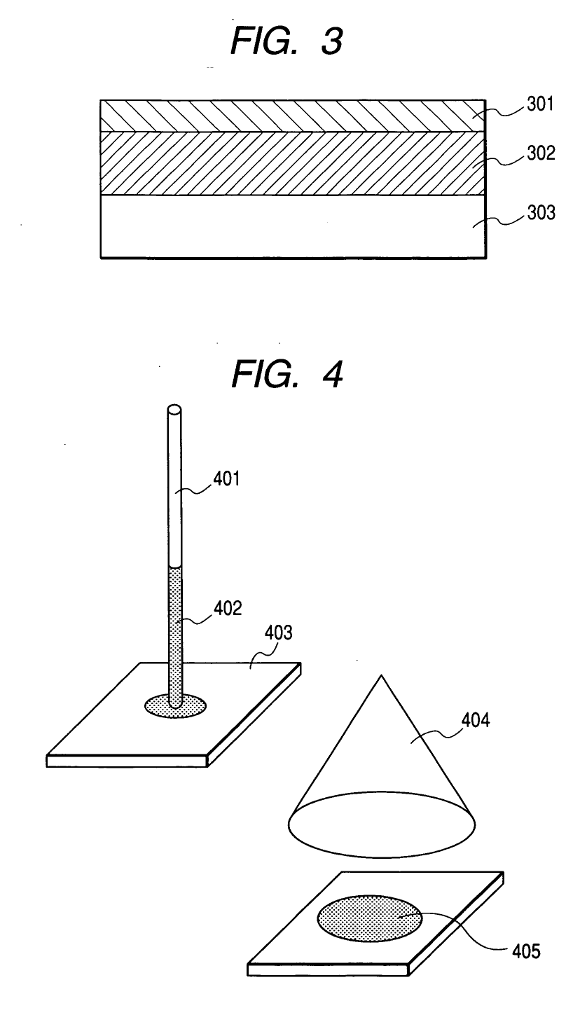

Now, a sampling table of the present invention will be described below by referring to FIG. 3. FIG. 3 is a schematic cross sectional view of an embodiment of sampling table according to the invention. In FIG. 3, 303 denotes a substrate and 302 denotes a segregator as a mechanism capable of segregating an object, while 301 denotes an ionization promoter.

While the ionization promoter 301 may be arranged only on the surface of the segregator 302, it may also be contained in the inside of the segregator. An ionization promoter 301 is formed on the surface of a segregator 302 preferably by sputtering, evaporation, CVD, electrolytic precipitation or some other appropriate process.

When the ionization promoter 301 is arranged on the segregator 302, it will be difficult to detect the object when the arranged ionization promoter 301 is too thick. For the purpose of the present invention, the thickness of the layer of the ionization promoter 301 is preferably not greater than 100 nm, more preferably not greater than 10 nm, most preferably not greater than 5 nm. There is no lower limit for the thickness of the layer of the ionization promoter 301 so long as the ionization accelerating feature is expressed and the object can be analyzed. According to the findings of the inventors of the present invention, it is possible to analyze the object when the density of the ionization promoter arranged on the segregator is not lower than 10¹⁰ atoms/cm².

When thin film chromatography is used for segregation, the segregator 302 is preferably in the form of sintered glass having desired pores and rigidly secured to the substrate or cellulose rigidly secured to the substrate.

When electrophoresis is used for segregation, the segregator 302 is preferably in the form of a gelled substance having desired pores, e.g., polyacrylamide gel or agarose gel. When the object is segregated from the sample by electrophoresis, it can be segregated by dropping said gel onto the sample and applying a predetermined electric field (e.g., 100V) thereto so as to maintain the application of the predetermined electric field for a predetermined period of time.

Now, the method of segregating an object by using a sampling table according to the invention will be described below by referring to FIG. 4. In FIG. 4, 401 denotes a glass capillary and 402 denotes a sample solution, while 403 denotes a sampling table carrying an ionization promoter and 404 and 405 respectively denote an (atomized) agent for decomposing the object and an extended sample spot.

According to the present invention, a sampling table may refer to an entire plate to be used for thin-layer chromatography with or without a holder to which it is rigidly fitted in order to fit the plate to a time of flight secondary ion mass spectrometry apparatus.

A sampling table according to the invention includes an ionization promoter and has a mechanism or a feature for segregating the object. When a sampling table according to the invention is used, a step of decomposing the segregated object may be provided if necessary.

For example, the object can be segregated from the sample solution 402 by preparing a sampling table carrying silver deposited on it as ionization promoter (an plate carrying silver deposited on it so as to be used for thin-layer chromatography) 403 and extending the sample solution 402 on it by means of the glass capillary 401. Then, the object that has been segregated can be decomposed by spraying the atomized agent (in an atomized state) 404 that is adapted to decompose the object onto the extended sample spot 405.

The above-described series of operation can be conducted efficiently by arranging, if necessary, a spraying means for spraying the agent (in an atomized state) 404 that is adapted to decompose the object to an information acquisition apparatus according to the invention.

Now, the present invention will be described further by way of examples. While the examples described below represent the best modes of carrying out the invention, the present invention is by no means limited to such modes of carrying out the invention.

### EXAMPLE 1

Preparation of a Plate for the Segregated Bio-Related Sample to be Analyzed (1)

A plate to be used for thin-layer chromatography (RP-18, tradename, available from Merck, film layer thickness: 0.2 mm) is cut to dimensions of 30 mm×5 mm and an Ag mono-atomic layer is formed on the plate by sputtering.

Then, a mixed aqueous solution containing 10 μM of each of synthesized peptide I (peptide arrangement: GGGGCGGGGG, C₂₁H₃₄N₁₀O₁₁S (average molecular weight: 634.61, the molecule weight of the molecule formed by elements showing the highest isotopic abundance ratios: 634.21, purchased from Sigmagenosis Japan) and synthesized peptide II (peptide arrangement: GGGGCEGGGG, C₂₄H₃₈N₁₀O₁₃S (average molecular weight: 706.79, the molecule weight of the molecule formed by elements showing the highest isotopic abundance ratios: 706.23, purchased from Sigmagenosis Japan) is prepared. The prepared aqueous solution is dropped by 10 μl onto a central part of the plate and extended by causing a 1:1 (volume ratio) solution of acetonitril containing trifluoroacetate by 0.1 vol % and distilled water to permeate the former aqueous solution by means of a glass capillary tube. A plurality of such samples are prepared.

### EXAMPLE 2

TOF-SIMS Analysis of the Samples Prepared in Example 1

The samples prepared in Example 1 are dried in air and then analyzed by means of a TOF-SIMS IV type apparatus (available from ION TOF). The measurement conditions are summarized below:

primary ions: 25 kV Ga+, 0.6 pA (pulse electric current value), random scan mode;

pulse frequency of primary ions: 2.5 kHz (400 μs/shot);

pulse width of primary ions: about 1 ns;

primary ion beam diameter: about 5 μm;

range of measurement: macro-raster (30 mm×5 mm); and

number of times of additions: 256.

When both the positive and negative secondary ion mass spectra are measured under the above conditions, it is possible to detect secondary ions that correspond to the mass of the synthesized peptide I, to whose parent molecule Ag is added along with a carbon atom and an oxygen atom, in the positive secondary ion mass spectrum. Similarly, it is possible to detect secondary ions that correspond to the mass of synthesized peptide II, to whose parent molecule Ag is added along with a carbon atom and an oxygen atom, in the positive secondary ion mass spectrum.

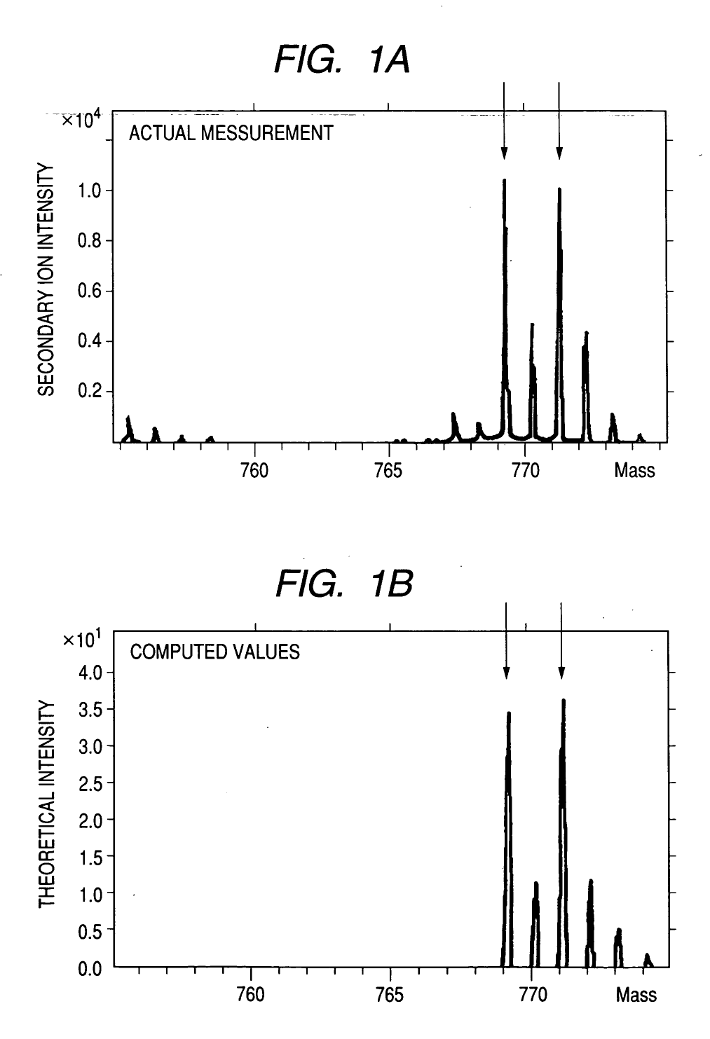

FIG. 1A shows an enlarged spectrum of synthesized peptide I in the above region obtained by an actual measurement and FIG. 1B shows an enlarged theoretical spectrum of synthesized peptide I in the above region obtained by computations on the basis of the isotopic abundance ratio. In FIGS. 1A and 1B, the peaks indicated by arrows correspond to the above cited ion [(synthesized peptide I)+(Ag)+(CO)]⁺. The two arrows in each of the graphs correspond respectively to the two isotopes of Ag (mass numbers: 107, 109). The right peak indicated by an arrow in each graph reveals that it contains ¹⁰⁹Ag and its m/z value (771.2) substantially agrees with the theoretical value of [(synthesized peptide I)+(¹⁰⁹Ag)+(CO)]⁺. A similar spectrum is obtained for synthesized peptide II. It is possible to obtain two-dimensional images that reflect the two-dimensional distribution of synthesized peptide I and that of synthesized peptide II by using secondary ions that correspond to parent ions of synthesized peptides I and II.

Synthesized peptides I and II can be segregated on a thin film chromatograph where an Ag mono-atomic layer is formed with an enhanced level of reproducibility.

Note that no secondary ion peak that corresponds to parent ions is observed on a plate for thin-layer chromatography where no Ag mono-atomic layer is formed. Similarly, no secondary ion peak is observed in the mass region that corresponds to that of parent ions.

### EXAMPLE 3

Preparation of a Plate for the Segregated Bio-Related Sample to be Analyzed (2)

A plate to be used for thin-layer chromatography (RP-18, tradename, available from Merck, film layer thickness: 0.2 mm) is cut to dimensions of 30 mm×5 mm to prepare a plate for segregating the sample.

Then, a mixed aqueous solution containing 10 μM of each of synthesized peptide I and synthesized peptide II that is similar to Example 1 is prepared. The prepared aqueous solution is dropped by 10 μl onto a central part of the plate and extended by causing a 1:1 (volume ratio) solution of acetonitril containing trifluoroacetate by 0.1 vol % and distilled water to permeate the former aqueous solution by means of a glass capillary tube. A 10 μM silver nitrate aqueous solution is sprayed onto it until the surface of the plate becomes slightly wet. A plurality of such samples are prepared.

### EXAMPLE 4

TOF-SIMS Analysis of the Samples Prepared in Example 3

The samples prepared in Example 3 are dried in air and then analyzed by means of a TOF-SIMS IV type apparatus (available from ION TOF). The measurement conditions are the same as those of Example 2.

As a result, peaks similar to those of Example 2 are observed. It is possible to obtain two-dimensional images that reflect the two-dimensional distribution of synthesized peptide I and that of synthesized peptide II by using secondary ions that correspond to parent ions of synthesized peptides I and II.

Synthesized peptides I and II can be segregated on a thin film chromatograph after spraying the aqueous solution of silver nitrate with an enhanced level of reproducibility.

Note that no secondary ion peak that corresponds to parent ions is observed on a plate for thin-layer chromatography where no aqueous solution of silver nitrate is sprayed. Similarly, no secondary ion peak is observed in the mass region that corresponds to that of parent ions.

### EXAMPLE 5

Preparation of a Plate for the Segregated Bio-Related Sample to be Analyzed (3)

A plate to be used for thin-layer chromatography (RP-18, tradename, available from Merck, film layer thickness: 0.2 mm) is cut to dimensions of 30 mm×5 mm and an Ag mono-atomic layer is formed on the plate by sputtering.

Two ml of blood of a healthy person is taken and 2 ml of acetonitril containing trifluoro acetate by 0.2 vol % is added thereto. The mixture is finely ground in a mortar and further treated by an ultrasonic wave for 10 minutes. It is then subjected to centrifugation (50,000G×60 minutes) and the obtained supernatant liquid I is separated. The above operation needs to be conducted carefully in such a way that all the samples are held to about 4° C.

One ml of the separated supernatant liquid I is lyophilized and dissolved into 20 μl of distilled water. The solution is then subjected to centrifugation (50,000G×60 minutes) to obtain lope of final supernatant liquid. The 10 μl of the final supernatant liquid is dropped onto a central part of the plate and extended by causing a 1:1 (volume ratio) solution of acetonitril containing trifluoroacetate by 0.1 vol % and distilled water to permeate the former aqueous solution by means of a glass capillary tube. A plurality of such samples are prepared (samples I).

As samples for comparison, 1 ml of the supernatant liquid I is lyophilized and 200 μg of cholesterol (C₂₇H₄₆O: average molecular weight: 386.73, the molecule weight of the molecule formed by elements showing the highest isotopic abundance ratios: 386.35) is added thereto. The mixture is then dissolved into 20 μl of distilled water. The aqueous solution is then subjected to centrifugation (50,000G×60 minutes) to obtain 10 μl of final supernatant liquid. The 10 μl of the final supernatant liquid is dropped onto a central part of the plate and extended by causing a 1:1 (volume ratio) solution of acetonitril containing trifluoroacetate by 0.1 vol % and distilled water to permeate the former aqueous solution by means of a glass capillary tube. A plurality of such samples are prepared (samples II).

### EXAMPLE 6

TOF-SIMS Analysis of the Samples Prepared in Example 5

The samples prepared in Example 5 are dried in air and then analyzed-by means of a TOF-SIMS IV type apparatus (available from ION TOF). The measurement conditions are the same as those of Example 2.

As a result, it is possible to detect secondary ions that correspond to the mass of the each of the samples I and the samples II, to whose parent molecule Ag is added, in the positive secondary ion mass spectrum. It is possible to obtain two-dimensional images that reflect the two-dimensional distribution of samples I and that of samples II by using secondary ions that correspond to parent ions of cholesterol. While the images of the two different samples are observed at the same position, the intensity of the samples II is about three times greater than that of the samples I.

### EXAMPLE 7

Preparation of a Plate for the Segregated Bio-Related Sample to be Analyzed (4)

A plate to be used for thin-layer chromatography (RP-18, tradename, available from Merck, film layer thickness: 0.2 mm) is cut to dimensions of 30 mm×5 mm and an Ag mono-atomic layer is formed on the plate by sputtering.

Then, a mixed aqueous solution containing 20 μM of each of synthesized peptide I and synthesized peptide II that is similar to Example 1 is prepared. Then, 100 μl is taken from each of the aqueous solutions and 100 μl of a 1.5 μg/μl solution (0.1M sodium phosphate buffer solution, pH: 8.0) of endoproteinase-Glu-C (which specifically decomposes the C-end side of E and D of protein/peptide) is added thereto as protease and the mixed solution is incubated at 37° C. for 18 hours. The treated solution is dropped onto a central part of the plate and extended by causing a 1:1 (volume ratio) solution of acetonitril containing trifluoroacetate by 0.1 vol % and distilled water to permeate the former aqueous solution by means of a glass capillary tube. A plurality of such samples are prepared.

### EXAMPLE 8

TOF-SIMS Analysis of the Samples Prepared in Example 7

The samples prepared in Example 7 are dried in air and then analyzed by means of a TOF-SIMS IV type apparatus (available from ION TOF). The measurement conditions are the same as those of Example 2.

As a result, peaks similar to those of Example 2 are observed. However, the peaks that correspond to synthesized peptide II are very low. On the other hand, peaks that correspond to parent ions of GGGGC and EGGGG, to which Ag is added, are confirmed. It is possible to obtain two-dimensional images that reflect the two-dimensional distribution of the decomposed product deriving from synthesized peptide I and that of the decomposed product deriving from synthesized peptide II by using such secondary ions.

Synthesized peptides I and II can be segregated on a thin film chromatograph where an Ag mono-atomic layer is formed with an enhanced level of reproducibility.

Note that no secondary ion peak that corresponds to parent ions is observed on a plate for thin-layer chromatography where no Ag mono-atomic layer is formed. Similarly, no secondary ion peak is observed in the mass region that corresponds to that of parent ions.

### EXAMPLE 9

Preparation of a Plate for the Segregated Bio-Related Sample to be Analyzed (5)

A plate to be used for thin-layer chromatography (RP-18, tradename, available from Merck, film layer thickness: 0.2 mm) is cut to dimensions of 30 mm×5 mm and an Ag mono-atomic layer is formed on the plate by sputtering.

Then, a mixed aqueous solution containing 10 μM of each of synthesized peptide I and synthesized peptide II that is similar to Example 1 is prepared. The prepared aqueous solution is dropped by 10 μl onto a central part of the plate and extended by causing a 1:1 (volume ratio) solution of acetonitril containing trifluoroacetate by 0.1 vol % and distilled water to permeate the former aqueous solution by means of a glass capillary tube. Then, a 1.5 μg/μl solution (0.1M sodium phosphate buffer solution, pH: 8.0) of endoproteinase-Glu-C is sprayed onto it as protease until the surface of the plate becomes slightly wet and the mixed solution is incubated at 37° C. for 18 hours. A plurality of such samples are prepared.

### EXAMPLE 10

TOF-SIMS Analysis of the Samples Prepared in Example 9

The samples prepared in Example 9 are dried in air and then analyzed by means of a TOF-SIMS IV type apparatus (available from ION TOF). The measurement conditions are the same as those of Example 2.

As a result, peaks similar to those of Example 2 are observed. However, the peaks that correspond to synthesized peptide II are very low. On the other hand, peaks that correspond to parent ions of GGGGC and EGGGG, to which Ag is added, are confirmed at positions corresponding to synthesized peptide II in Example 2. It is possible to obtain two-dimensional images that reflect the two-dimensional distribution of the decomposed product deriving from synthesized peptide I and that of the decomposed product deriving from synthesized peptide II by using such secondary ions.

Synthesized peptides I and II can be segregated on a thin film chromatograph where an Ag mono-atomic layer is formed with an enhanced level of reproducibility.

Note that no secondary ion peak that corresponds to parent ions is observed on a plate for thin-layer chromatography where no Ag mono-atomic layer is formed. Similarly, no secondary ion peak is observed in the mass region that corresponds to that of parent ions.

The present invention is expected to find applications as a technique for acquiring information on the-health-condition of a subject and hence is very valuable.

With a method according to the invention, it is possible to segregate organic substances of a sample, which is a mixture thereof, to respective characteristic positions and observe images thereof by means of “mass information” of each of them. Thus, it is possible to visualize the two-dimensional distribution of the mixture of the organic substances with a high degree of spatial resolution (of about 1 μm) and obtain “positional information” that provides a cue for identifying the organic substances in addition to the “mass information”. It is also possible to acquire information on the health condition of an subject by forming a database where each detected organic substance is correlated with the health condition for each specific bio-sample such as blood on the basis of the information of the above two categories.

Additionally, since the sampling table for rigidly holding a sample is removable from the information acquisition apparatus, the sampling table can be hand-carried and the sample can be rigidly secured to the sampling table at a position close to the subject.

This application claims priority from Japanese Patent Application No. 2004-171304 filed Jun. 9, 2004, and Japanese Patent Application No. 2004-369417 filed Dec. 21, 2004 which are hereby incorporated by reference herein.

1. An information acquisition method of acquiring a secondary ion mass spectrum of an object by means of time of flight secondary ion mass spectroscopy, said method comprising:
a first step of-segregating the object;
a second step of applying an ionization promoter to said object; and
a third step of obtaining a secondary ion mass spectrum of the object by means of time of flight secondary ion mass spectroscopy.

2. The method according to claim 1, further comprising:
a step of decomposing the object by way of a chemical process after said first step.

3. The method according to claim 1, wherein said first step of segregating the object is a step of segregating the object by electrophoresis or thin-layer chromatography that involves the use of a segregator containing an ionization promoter and having a mechanism capable of segregating the object.

4. The method according to claim 3, further comprising:
a step of decomposing the object by way of a chemical process after said first step.

5. The method according to claim 1, wherein
said object is a bio-related substance.

6. The method according to claim 5, wherein
said bio-related substance is a nucleic acid, a protein or a decomposition product thereof obtained by decomposition by way of a chemical process.

7. The method according to claim 1, wherein
said ionization promoter is silver, gold or a mixture thereof.

8. The method according to claim 1, wherein
information on the two-dimensional distribution of said object is acquired by scanning a primary ion beam.

9. An information acquisition apparatus comprising a time-of-flight type-secondary ion mass spectrometer, a sampling table of the apparatus containing an ionization promoter and having a mechanism for segregating the object.

10. An information acquisition apparatus comprising a time-of-flight type secondary ion mass spectrometer, a sampling table of the apparatus containing an ionization promoter and having a mechanism for segregating the object and a mechanism for decomposing the segregated object by way of a chemical process.

11. A sampling table for time of flight secondary ion mass spectroscopy, said sampling table containing an ionization promoter and having a mechanism for segregating the object.

12. The sampling table according to claim 11, wherein
said sampling table is a plate for thin-layer chromatography containing an ionization promoter.

13. A method of acquiring information on health condition by means of an information acquisition method according to any one of claims 1 through 8, wherein said object is a sample taken from a living body.

14. The method according to claim 13, wherein
said sample is rigidly secured to the sampling table that is removable from an information acquisition apparatus.

15. The method according to claim 13, wherein
information on health condition is acquired from said sample by comparing the acquired secondary ion mass spectrum information and the segregated pattern information with library data of secondary ion mass spectrum information and segregated pattern information prepared in advance to correspond to various health conditions.
